(19) United States
(12) Patent Application Publication
(10) Pub. No.: US 2017/0219208 A1
(43) Pub. Date: Aug. 3, 2017

(54) METHODS AND SYSTEMS FOR MONITORING BURNER FLAME CONDITIONS IN A FURNACE

(71) Applicant: ExxonMobil Research and Engineering Company, Annandale, NJ (US)

(72) Inventors: Limin Song, West Windsor, NJ (US); Yibing Zhang, Annandale, NJ (US)

(21) Appl. No.: 15/404,641

(22) Filed: Jan. 12, 2017

Related U.S. Application Data
(60) Provisional application No. 62/280,328, filed on Jan. 19, 2016.

(51) Int. Cl. F23N 5/16; F23N 5/24; G01H 9/00

(52) U.S. Cl. CPC F23N 5/16; G01H 9/004; F23N 5/242; F23N 2005/165; F23N 2023/08; F23N 2023/00

(57) ABSTRACT

Systems and methods for using at least one sensor for monitoring a condition in a furnace are disclosed. The at least one sensor can be an optical fiber acoustic sensor. The at least one sensor can be coupled to at least one processor that can be configured to receive at least one measurement from the sensor, convert the at least one measurement into a digital format, and determine a condition associated with at least one burner based at least in part on the digital format. The digital format can be, for example, a sound waveform or a frequency spectrum.

### CROSS-REFERENCE TO RELATED APPLICATIONS

This application claims priority to U.S. Provisional Application Ser. No. 62/280,328 filed Jan. 19, 2016, which is herein incorporated by reference in its entirety.

### BACKGROUND

Field of the Invention

The presently disclosed subject matter relates to methods and systems for monitoring burner flame performance. More particularly, the presently disclosed subject matter relates to detecting one or more unstable burners within a furnace having multiple burners.

Description of the Related Art

Components of certain equipment, such as that used in the petroleum and petrochemical industry, which includes the exploration, production, refining, manufacture, supply, transport, formulation or blending of petroleum, petrochemicals, or the direct compounds thereof, are often monitored to maintain reliable and optimal operation. However, such components can involve harsh conditions, such as high temperature, high pressure, and/or a corrosive environment, making it difficult or costly to obtain reliable measurements.

Monitoring burner flame conditions can provide for enhanced control of an operation. Industrial furnaces, fired heaters, and boilers are used extensively across multiple refinery and manufacturing processes, such as process heating and steam production, and are generally responsible for a large proportion of fuel consumption. The proper operation of these furnaces can be relevant for safety, environmental, and energy efficiency concerns.

In addition, industrial furnaces can contribute substantially to total NOx emissions. NOx emissions can be reduced through lowering the adiabatic flame temperature while maintaining safe operation, which can be achieved by, e.g., enhancing flue gas recirculation, steam injection, or use of technologies such as premixed flames and ultra-low NOx burners. However, these technologies can be more prone to flame instability than traditional processes. It therefore remains necessary to monitor burner stability and provide feedback signals to control fuel and/or diluent flow when instabilities occur.

Traditionally, flame monitoring in industrial furnaces has been accomplished through visual inspection, analyzer-based monitoring, and photodetector devices. Visual inspection can readily identify flame blowoff, but is generally inadequate for identifying instability prior to blowoff. Analyzer-based monitoring typically has long latency and lacks the dynamic coverage needed for reliable detection. Photodetector devices such as flame eye are mainly burner based and expensive for wide-deployment. Furthermore, the practical use of line-of-sight techniques, such as Tunable Diode Laser-based monitoring, can be restricted due to their design.

New flame monitoring strategies have been introduced, but are limited in various ways. For example, variance-based approaches have been proposed, but have low output signal-to-noise ratio, which requires an operator to choose between early detection and a low false positive rate. In addition, draft pressure fluctuation approaches have been reported in the past, but these techniques have been limited to a specific frequency range.

There thus remains a continued need for improved techniques for monitoring the burner flame condition within industrial furnaces. The presently disclosed subject matter satisfies these and other needs.

### SUMMARY OF THE INVENTION

The purpose and advantages of the disclosed subject matter will be set forth in and apparent from the description that follows, as well as will be learned by practice of the disclosed subject matter. Additional advantages of the disclosed subject matter will be realized and attained by the method and systems particularly pointed out in the written description and claims hereof, as well as from the appended drawings. To achieve these and other advantages and in accordance with the purpose of the disclosed subject matter, as embodied and broadly described, the disclosed subject matter includes systems and methods for detecting instability in a furnace.

In accordance with one aspect of the presently disclosed subject matter, a method for detecting an instability in a furnace having one or more burners includes obtaining from at least one sensor a plurality of first measurements related to the one or more burners when the furnace is operating in a stable condition and determining, based at least in part on the plurality of first measurements from the at least one sensor, a stable signal component representation for the furnace. The method further includes obtaining from the at least one sensor a plurality of second measurements related to the one or more burners when the furnace is operating in an unknown state and determining, based at least in part on the plurality of second measurements and the stable signal component representation, an unstable signal component representation for the furnace. The method further includes detecting, using at least one processor, an instability in the furnace based at least in part on the unstable signal component representation and an instability threshold.

In certain embodiments, the sensor can be an optical fiber acoustic sensor. The stable signal component can include a sound waveform and/or a frequency spectrum. The stable signal component can be a stable covariance matrix and the unstable signal component representation can be an instability component covariance, that can be calculated based on a stable covariance matrix and a current covariance matrix.

In accordance with another aspect of the presently disclosed subject matter, a method for identifying, in a furnace having a plurality of burners, an unstable subset of burners includes obtaining a plurality of measurements from at least one acoustic sensor, detecting an instability associated with the furnace, computing, using at least one processor, an unstable signal matrix associated with the instability based on the at plurality of measurements and identifying the unstable subset of burners based at least in part on the unstable signal matrix.

In certain embodiments, the method can use eigenvalue decomposition of the unstable signal component representation to obtain at least one dominant eigenvector which can include three components defining a point on a unit ball. The method can include clustering a point with a plurality of other points obtained from a plurality of previous dominant eigenvectors and identifying the unstable subset of burners based on the clustering.

In accordance with another aspect of the presently disclosed subject matter, a system for monitoring a condition in a furnace having one or more burners can include at least one acoustic sensor and at least one processor coupled to the at least one acoustic sensor and configured to receive at least one measurement from the at least one acoustic sensor, convert the at least one measurement into a digital format, and determine a condition associated with at least one burner based at least in part on the digital format.

In certain embodiments, the acoustic sensor can be configured to obtain the at least one measurement when the furnace is operating in a stable condition. In certain embodiments, the acoustic sensor can include an optical fiber. The optical fiber can include fiber grating.

In certain embodiments, the processor can be configured to convert the at least one measurement into the digital format by determining, based at least in part on the at least one measurement, a stable signal component representation for the furnace. The processor can be further configured to receive from the at least one acoustic sensor at least one second measurement when the furnace is operating in an unknown state and determine, based at least in part on the at least one second measurement, an unstable signal component representation for the furnace.

The methods and systems can monitor various conditions in the furnace, including an instability, a flameout, or an irregular flame. The methods and systems can use historical data and/or pattern recognition techniques. The methods and systems can provide one or more mitigation recommendations to an operator based on the condition.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

FIG. 1 is a schematic diagram of an exemplary system for monitoring a condition in a furnace in accordance with the disclosed subject matter.

FIG. 2 is a schematic diagram of an exemplary method for detecting an instability in a furnace in accordance with the disclosed subject matter.

FIG. 3 is a schematic diagram of an exemplary method for identifying an unstable subset of burners in accordance with the disclosed subject matter.

FIG. 4 is a schematic diagram of an exemplary pre-processing method in accordance with the disclosed subject matter.

FIG. 5 is a schematic diagram of an exemplary method for calculating the unstable signal component representation in accordance with the disclosed subject matter.

FIG. 6 is a schematic diagram of an exemplary method for identifying the unstable subset of burners based on the unstable signal matrix in accordance with the disclosed subject matter.

### DETAILED DESCRIPTION

As noted above and in accordance with one aspect of the disclosed subject matter, methods disclosed herein include detecting an instability in a furnace having a plurality of burners.

In accordance with one aspect of the presently disclosed subject matter, methods for detecting an instability in a furnace having one or more burners include obtaining from at least one sensor a plurality of first measurements related to the one or more burners when the furnace is operating in a stable condition, determining, based at least in part on the plurality of first measurements from the at least one sensor, a stable signal component representation for the furnace, obtaining from the at least one sensor a plurality of second measurements related to the one or more burners when the furnace is operating in an unknown state, determining, based at least in part on the plurality of second measurements and the stable signal component representation, an unstable signal component representation for the furnace, and detecting, using at least one processor, an instability in the furnace based at least in part on the unstable signal component representation and an instability threshold.

Furthermore, methods for identifying, in a furnace having a plurality of burners, an unstable subset of burners from among the plurality of burners include obtaining a plurality of measurements from at least one acoustic sensor, detecting an instability associated with the furnace, computing, using at least one processor, an unstable signal matrix associated with the instability based on the at plurality of measurements, and identifying the unstable subset of burners based at least in part on the unstable signal matrix.

In accordance with one aspect of the presently disclosed subject matter, systems for monitoring a condition in a furnace include at least one acoustic sensor and at least one processor coupled to the at least one sensor and configured to receive at least one measurement from the acoustic sensor, convert the at least one measurement into a digital format, and determine a condition associated with at least one burner based at least in part on the digital format. In certain embodiments, the processor can be further configured to determine the condition associated with the at least one burner by detecting an instability in the furnace based at least in part on the unstable signal component representation and an instability threshold.

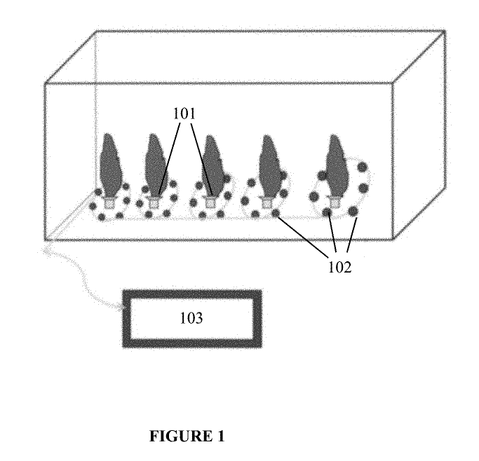

Reference will now be made in detail to the various exemplary embodiments of the disclosed subject matter. The accompanying figures, where like reference numerals refer to identical or functionally similar elements, serve to further illustrate various embodiments and to explain various principles and advantages all in accordance with the disclosed subject matter. For purpose of explanation and illustration, and not limitation, exemplary embodiments of the disclosed subject matter are shown in FIGS. 1-6.

Although the methods and systems disclosed herein will be described in conjunction with each other for clarity, they can be used independently. For example, a method can detect an instability in accordance with the disclosed subject matter without thereafter proceeding to the identification of an unstable subset of burners. Similarly, a method for identifying an unstable subset of burners in accordance with the disclosed subject matter can be used regardless of how the instability is detected.

With reference to FIG. 1, the furnace can include one or more burners 101. The term “furnace,” as used herein, refers to a wide variety of equipment that includes at least one burner, including, for example, industrial furnaces, fired heaters, and boilers. The furnace can be located at a refinery or similar location. The one or more burners can be present within a firebox of the burner. Each of the one or more burners can be coupled to one or more sensors 102, and further coupled to a processor 103.

With further reference to FIG. 1, a system for monitoring a condition in a furnace includes at least one sensor 102. The system also includes at least one processor 103 coupled to the at least one sensor to receive at least one measurement from the sensor, convert the measurement into a digital format, determine a condition associated with at least one burner based at least in part on the digital format.

In certain embodiments, the sensor 102 is an acoustic sensor. It is known that sound is produced during combustion in a furnace, for example by the turbulent flow of gases, the mixing and ratios of combustion reactants, the dynamics of heat release, and pressure fluctuations in the firebox. Given the geometry and dimensions of the furnace and burner, sound can be an indicator of furnace conditions.

Sound waves produce vibrations which can be measured by various types of acoustic sensors. The acoustic sensor for use in the presently disclosed subject matter can be adapted to measure sound and/or dynamic pressure variation. The output of the acoustic sensor can correspond to one or more acoustic parameters. For example, the output of the acoustic sensor can correspond to average sound pressure level, acoustic energy, or sound spectrum over a predetermined frequency range. If multiple acoustic sensors are used, additional parameters can be determined, including acoustic intensity and coherent phases (which can allow estimation of the location or origin of an acoustic source).

In one embodiment, the acoustic sensor includes optical fiber. One or more acoustic sensors can be arrayed on a single optical fiber cable. The optical fiber can be coated, for example with an acoustic coating to respond to sound vibrations. The optical fiber can include grating. Because such optical fiber acoustic sensors do not contain electronics, they are well suited to withstand temperature conditions within the furnace. For example, an optical fiber acoustic sensor can be placed in close proximity to one or more burners. Additionally, the use of optical fiber allows multiple acoustic sensors to be arrayed throughout a furnace. Thus, for example, in a furnace having multiple burners, one or more acoustic sensors can be placed to monitor each burner. In certain embodiments, multiple sensors can monitor each burner to increase the certainty of the sensor measurements.

A number of commercially available optical fibers can be used, such as a Fiber Bragg grating array, Raman scattering based sensor, Rayleigh scattering based sensor, or Brillouin scattering based sensor. One of ordinary skill in the art will appreciate that each type of fiber sensor can have certain properties, such as response time, sensing resolution, immunity to hydrogen darkening, effective sensing cable length, and ability to sense strain (e.g., sound vibrations), as illustrated for purpose of example and not limitation in Table 1. For example, a Fiber Bragg grating sensing system can include a relatively fast response time, high spatial resolution, and can be employed over a sensing cable length upwards of 100 km or longer in connection with the use of optical fiber amplifiers. Raman and Brillouin scattering sensing systems can have relatively low response times (e.g., on the order of several seconds), and spatial resolution on the order of centimeters. Rayleigh scattering sensing systems can have a relatively fast response time with relatively high spatial resolution.

TABLE 1

| | Fastest | Typical | Immunity | Longest |
|---|---|---|---|---|
| | response | point sensor | to H2 | sensor cable |
| Sensor types | time | size (m) | darkening | length |
| Fiber Bragg | <10 ms | 0.01 | high | <100 km or |
| Grating (FBG) | | | | longer |
| Raman | >several | 0.25~0.5 | low | <100 km |
| scattering sensor | seconds | | | |
| Rayleigh | <1 ms | 0.5 | low | <100 km |
| scattering sensor | | | | |
| Brillouin | >several | 0.1~50 | low | <100 km |
| scattering sensor | seconds | | | |

One of ordinary skill in the art will appreciate that certain of the various types of sensing systems can be used to sense strain (e.g., to sense acoustics). In certain embodiments, one or more of the various types of sensing systems are used in the acoustic sensor.

In alternative embodiments, other acoustic sensors, including a pressure sensor or vibration sensor, can be used. For example, a suitable pressure sensor can be a dynamic pressure sensor, such as a pressure probe, that can capture a high frequency signal and measure the draft pressure at a single point inside a furnace. For example, a suitable vibration sensor can be an accelerometer that can be used to measure the oscillation of the furnace wall or piping.

Other sensors can also be used without departing from the scope of the disclosed subject matter. For example, optical sensors can be used to measure flicker. In other embodiments, detectors for measuring carbon dioxide or sulfur dioxide levels in the furnace can be used. In other embodiments, a device, such as a video camera, can capture a series of video frames of burner flame conditions.

Although the disclosed subject matter is not limited to any particular theory of operation, a pressure signal at acoustic sensor a at time n can be modeled as:

xₐ[n]=x_{s,a}[n]+δxₐ[n] (1)

wherein x_{s,a}[n] is the stable pressure component for sensor a and δxₐ[n] is the unstable signal component for sensor a.

It is observed that stable combustion generates more or less random variations (e.g., in a measurement of pressure from sound vibrations), and therefore the frequency spectrum representing the sound of stable combustion can be modeled as a normal curve. In contrast, flame instability is typically coherent, as manifested by harmonic pressure oscillations. For example, vibrations from the sound and heat release caused by a flame instability can combine to form a frequency that is distinct from the frequency of normal combustion. As the instability persists, this frequency can amplify. In certain embodiments, a particular frequency associated with an instability can be determined using historical data and/or predictive modeling. For example, determining a frequency associated with an instability can take into account the geometry of the furnace, firebox, and/or burners, flue gas flow velocity, and/or furnace temperature.

In accordance with one embodiment of the disclosed subject matter, the method can use a plurality of sensors. The plurality of sensors can include one or more types of sensors, for example optical fiber acoustic sensors, pressure sensors, vibration sensors, optical sensors, devices that capture video frames, or sensors that measure carbon dioxide or sulfur dioxide levels.

As known in the art, sensors generally measure some characteristic of an environment at regular intervals. The frequency of the measurements can be described in terms of the number of measurements taken over a given time period, or the sampling rate. For example, if Sensor A takes one measurement every second, the sampling rate of Sensor A is 1 per second, or 1 Hertz. In order to obtain the best results, each of the sensors should have a common sampling rate. If at least some of the plurality of sensors do not have the same sampling rate, signals from one or more of the sensors will need to be pre-processed.

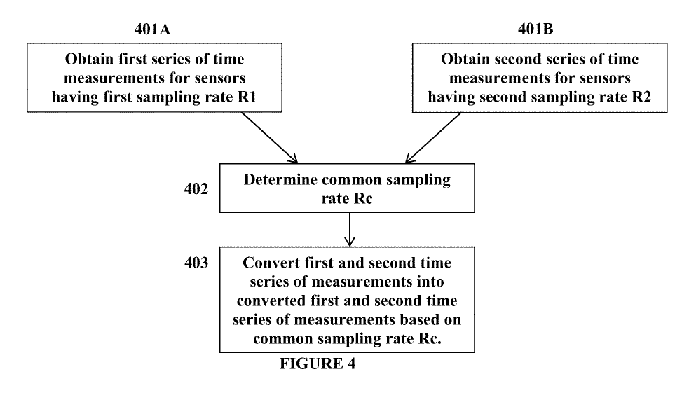

An exemplary pre-processing method in accordance with the disclosed subject matter is illustrated in FIG. 4. A first series of time measurements is obtained from one or more sensors having a first sampling rate R1 401A. Simultaneously, a second series of time measurements is obtained from each of the one or more sensors having a second sampling rate R1 401B.

The first time series of measurements and the second time series of measurements can be converted into a combined time series of measurements having a common sampling rate and a dynamic range. This conversion can include determining a common sampling rate and converting each of the first and second time series of measurements into a converted first and second time series of measurements based on the common sampling rate.

For example, and with further reference to FIG. 4, a common sampling rate Rc is determined 402. The common sampling rate can be determined based on any sampling techniques as known in the art. For example, the common sampling rate can be determined using Least Common Multiple-based upsampling when the first and second sampling rates are both low. Alternatively, the common sampling rate can be determined using Maximum Common Divisor-based downsampling when the first and second sampling rates are sufficiently high. The common sampling rate can be the first sampling rate R1. In another embodiment, the common sampling rate can be a sampling rate other than the first sampling rate and the second sampling rate. If the first sampling rate and the second sampling rate are the same (i.e., R1=R2 ), no upsampling or downsampling is needed.

Each of the first and second series of time series measurements is then converted into a converted times series of measurements based on the common sampling rate 403. If the common sampling rate is the first sampling rate R1, the first converted time series of measurements is the same as the first time series of measurements, and only the second series of measurements will need to be converted. If the common sampling rate is a sampling rate other than the first sampling rate and the second sampling rate, both the first and second series of measurements will need to be converted.

With further reference to FIG. 1, the system also includes at least one processor 103 configured to receive at least one measurement from the sensor, convert the measurement into a digital format, and determine a condition associated with at least one burner based at least in part on the digital format.

The processor can receive multiple measurements at a constant sampling rate. Where the sensor is measuring a waveform (e.g., sound), the sampling rate can be at least twice the frequency of the waveform. In certain embodiments, the sampling rate is at least four times the frequency of the waveform.

For purposes of example, the frequency associated with an instability can be less than about 100 Hz, while the frequency associated with normal combustion can be in the kilohertz range (i.e., from about 1 kHz to about 1000 kHz). The sampling rate can be modulated to capture the lower frequency of an instability. In certain embodiments, the processor can apply an anti-aliasing filter to the measurements to remove high frequencies.

In certain embodiments, the processor converts the multiple measurements into a sound waveform to display the frequency as a function of time. Alternately or additionally, the processor can convert the multiple measurements into a frequency spectrum to display a frequency distribution. For example, the processor can convert the multiple measurements into a frequency spectrum using a Fast Fourier Transform (FFT) algorithm.

The at least one processor 103 comprises one or more circuits. The one or more circuits can be designed so as to implement the disclosed subject matter using hardware only. Alternatively, the processor can be designed to carry out the instructions specified by computer code stored in a hard drive, a removable storage medium, or any other storage media. Such non-transitory computer readable media can store instructions that, upon execution, cause the at least one processor to perform the methods as disclosed herein.

The processor can also be coupled to non-transitory computer readable media for storing instructions. Non-transitory computer readable media can be, for example, RAM, ROM, or other storage media. Computer readable media contains instructions for the processor to receive at least one measurement from the at least one acoustic sensor, convert the at least one measurement into a digital format, and determine a condition associated with at least one burner based at least in part on the digital format. The digital format can be, for example, a sound waveform or a frequency spectrum. The condition can be, for example, an instability, a flameout, or an irregular flame. The processor can determine the condition by analyzing the digital format. The processor can be further configured to provide mitigation recommendations to an operator based on the condition. For example, the processor can recommend shutting down a furnace if a burner is approaching flameout.

The system can further include additional components. For example, the system can include an alarm coupled to the processor that is activated when an instability is detected. The alarm can be, for example, a siren, a flashing light, or any other alarm.

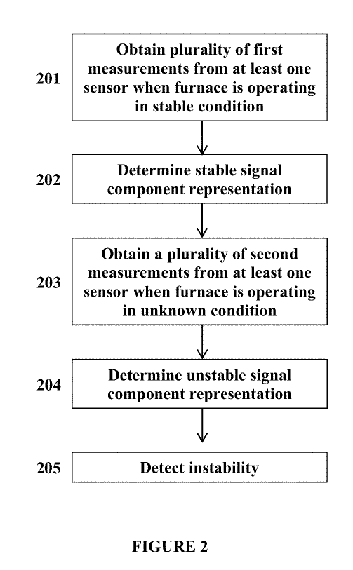

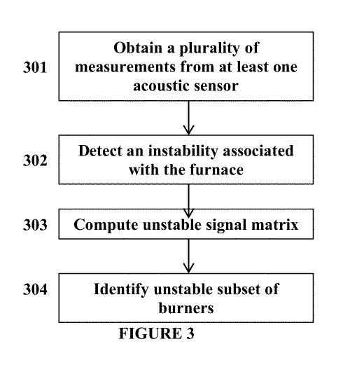

Using the systems as disclosed, and suitable modifications as desired, a method of detecting an instability while monitoring a furnace is provided and disclosed herein with reference to FIGS. 2-3.

With reference to FIG. 2, a method for detecting an instability in a furnace is shown. The method includes obtaining from at least one sensor a plurality of first measurements related to the furnace is operating in a stable condition 201. A stable signal component representation for the furnace is determined based at least in part on the plurality of first measurements from the acoustic sensor 202. The plurality of first measurements correspond to stable furnace condition and can be determined and recorded during stable furnace operation.

In one embodiment, the stable signal component representation is a stable statistic. For example, the stable signal component representation can be a stable covariance matrix. The stable covariance matrix, Qxs[m], at time m when the signal is known to be stable can be calculated as:

Qₓₛ[m]=Σ_{m∈stableduration}(x[]−x̅[m])(x[m]−x̅[m])^{t}/M−1) (2)

where x[m] is the vector of sensor measurements at time m, x̅[m] is the mean of x[m] estimated at time m, (x[m]−x̅[m])^{t} is the transpose of the vector x[m]−x̅[m] , and M is the length of the time window during which the stable covariance matrix is estimated.

In certain embodiments, the method further includes obtaining from at least one sensor a plurality of second measurements related to the furnace operating in an unknown state 203. An unstable signal component representation for the furnace is determined based at least in part on the plurality of second measurements and the stable signal component representation 204. As used herein, “unstable signal component” refers to the portion of the signal that is not attributed to the stable signal component, and does not denote that one or more of the burners in the furnace is necessarily unstable.

The unstable signal component representation can be an instability covariance matrix. The instability covariance matrix can be calculated based on the stable covariance matrix and a current covariance matrix. The current covariance matrix is a function of the second measurement from each of the plurality of detectors, and relates to the unknown state of the furnace.

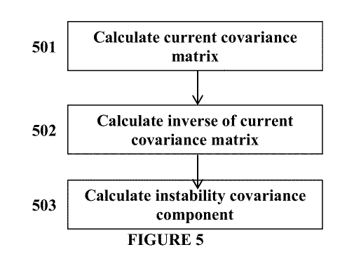

One embodiment of a method for calculating the unstable signal component representation in accordance with the disclosed subject matter is illustrated in FIG. 5. A p current covariance matrix Qₓ[n] is calculated 501. In accordance with one embodiment of the disclosed subject matter, the current covariance matrix can be calculated as:

Qₓ[n]=λQₓ[n−1]+x[n]x[n]^{t} (3)

where λ is the forgetting factor taking a value between [0,1] such that past data is discounted at a rate of λ^{t}^{₀}^{-t}, Qₓ[n−1] is the current covariance matrix for the previous time period, x[n] is the vector of the second measurements from each of the plurality of detectors, and x[n]^{t} is the transpose of vector x[n].

With further reference to FIG. 5, the inverse of the current covariance matrix is calculated 502. For example, the inverse of the current covariance matrix Qₓ⁻¹[n] can be calculated using matrix inversion lemma:

Qₓ⁻¹[n]=λ⁻¹Qₓ⁻¹[n−1]−λ⁻¹q[n]q[n]^{t}/(λ+x^{t}[n]q[n]) (4)

where

q[n]=Qₓ⁻¹[n−1]x[n]) (5)

The instability covariance component representation is then calculated 503. In one embodiment, the instability covariance component representation can be calculated as:

Q_{δx}[n]=Qₓ[n]−Qₓₛ (6)

This calculation can be followed by a projection to ensure that the resulting instability covariance matrix is non-negative.

With further reference to FIG. 2, an instability can be detected based at least in part on the unstable signal component representation and an instability threshold 205. Generally, an instability will be detected when the sensor, which can be based on the unstable signal component representation, exceeds the instability threshold. Although the word “instability” is used herein to denote unsatisfactory burner conditions, one of skill in the art will appreciate that the methods and systems disclosed herein can be used to detect precursor conditions to an instability and provide an alert or mitigation based on the detection of precursor conditions. The instability threshold can correspond to a deviation from normal combustion that indicates the presence of an unstable burner. The instability threshold can be established based on historical data and/or predictive modeling.

By way of example, frequency measurements obtained from the sensors can be filtered, e.g., using a digital band filter, to include only frequencies in a narrow range. The narrow range should encompass the frequencies associated with an instability. The instability threshold can be established based on historical data of the frequency associated with stable combustion. Using this instability threshold, an instability will be detected when the sensor measures a frequency that deviates from the frequencies of stable combustion by an amount greater than the instability threshold.

Because multiple sensors can be arrayed on a single fiber, the multiple sensors can be fused to reduce uncertainty in the measurements. By integrating the measurements of multiple sensors, sensor fusion can significantly improve the output signal to noise ratio. Improved signal to noise ratio can, in turn, improve the sensitivity of instability detection. Thus, sensor fusion can allow instabilities to be detected earlier and more accurately.

An alarm can be provided when an instability is detected. The alarm can be, for example, an audio alarm such as a siren or a visual alarm such as a flashing light or an indication on the monitor of a computer screen. More generally, any method of informing an operator that an instability has been detected can be used as known in the art for its intended purpose.

Corrective action can also be taken when an instability is detected, either manually or automatically. For example, the furnace can be shut down, which can prevent an explosion and allow repairs and/or maintenance to be provided to the furnace. In another embodiment, an operating condition of the furnace can be adjusted. For example, the amount of steam and/or fuel injected into the furnace can be decreased until the instability is resolved.

As discussed above, the first measurements corresponding to stable furnace conditions can be recorded and measured while the furnace is operating in a stable condition, that is, prior to any unstable conditions. Further, the method can at least partially use historical data to detect an instability. Additionally or alternatively, the method can incorporate data-driven approaches to detect instabilities. For example, the method can incorporate a data-learning algorithm and/or pattern recognition techniques to improve furnace monitoring and instability detection.

In furnaces with a large number of burners, an instability caused by one burner can have significant impact on the operation of the furnace and system as a whole. For example, one unstable burner can require that an entire furnace be shut down although all of the other burners are stable. This is both environmentally and economically inefficient. Moreover, once a furnace has been shut down, it may take an extended period of time to investigate which burner is responsible for the instability. In the event of an inconclusive investigation, the operator may replace one or more burners based on his or her best judgment. This “best judgment” replacement strategy can be both costly and ineffective.

The disclosed subject matter therefore provides systems and methods for identifying an unstable subset of burners. In the discussion herein, the phrase “subset of burners” refers to any number of burners that is less than the total number of burners associated with a furnace. The term “subset of burners” can reference a single burner, or the term “subset of burners” can refer to two or more burners that are unstable. Furthermore, the term “subset of burners” can refer to a group of any number of burners, wherein at least one burner is unstable (i.e., one or more burners of the subset can be stable). Additionally, the system and methods disclosed herein may identify a subset of burners in accordance with this final embodiment when there are more burners than detectors.

With reference to FIG. 3, in one embodiment, the method includes obtaining a plurality of measurements from at least one acoustic sensor 301 and detecting an instability associated with the furnace 302.

In accordance with one embodiment of the disclosed subject matter, the instability can be detected as discussed above with reference to, for example, the method of FIG. 2 as previously described in detail. However, the method for identifying an unstable subset of burners in accordance to the disclosed subject matter is not limited to such embodiment. Other methods can also be used as known in the art and suitable for their intended purpose. For example, a variance-based instability detector can be used to detect an instability. Alternatively, a point measurement, such as gathered from a thermocouple, pressure gauge, or microphone, can be used to detect an instability.

With further reference to FIG. 3, the method can further include computing, using at least one processor, an unstable signal matrix associated with the instability based on the at plurality of measurements and identifying the unstable subset of burners based at least in part on the unstable signal matrix 303. The unstable signal matrix can be the instability component covariance as previously discussed herein with reference to FIG. 5.

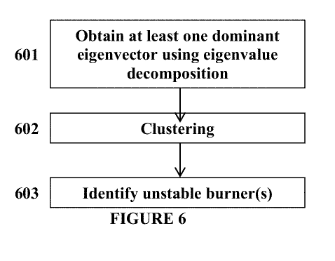

One embodiment of the method for identifying the unstable subset of burners based on the unstable signal matrix in accordance with the disclosed subject matter is illustrated in FIG. 6.

With reference to FIG. 6, at least one dominant eigenvector of the unstable signal matrix is obtained using eigenvalue decomposition 601. The method for obtaining an eigenvector is well known in the art, and can be represented as:

[V,D]=eig(Q_{δx}[n]) (7)

where D represents the dominant eigenvalues and V represents the associated eigenvectors. In the case of a single unstable burner, the Greens function vector \tilde{g}ₘ, which relates to the mapping from the unstable burner(s) to the plurality of sensors, can be recovered from the first dominant eigenvector of Q_{δx}[n]:

\tilde{g}ₘαV(:,1) (8)

where α is a scaling factor that normalizes the Greens function and V (:,1) is the first dominant eigenvector. The principle of linear superposition applies in the case of multiple unstable burners. Thus, the dominant eigenvector is directly correlated to the Green's function vector and can be used to identify the unstable subset of burners.

The length of the eigenvectors will depend on the number of sensors deployed in the furnace and used in the calculation of the unstable signal matrix. For example, in a furnace with three pressure sensors, the eigenvector will be 3×1.

With further reference to FIG. 6, clustering is performed based on the dominant eigenvector 602. Clustering generally refers to grouping data recovered from the current dominant eigenvector and a plurality of previous dominant eigenvectors. For example, in one embodiment the furnace has three detectors. As discussed above, the resulting eigenvector will be 3×1. The three components of this eigenvector define a point on a unit ball. The point corresponding to the three components of the eigenvector can be plotted on the unit ball along with points corresponding to the three components of the plurality of previous eigenvectors.

More generally, while the first dominant eigenvector represents a combined effect of all unstable burners, other eigenvectors may also contain information that is useful for burner identification. In such case, the unit ball concept can easily be generalized to a higher dimensional clustering with additional eigenvectors as feature vectors. Although visualization in the higher dimensional space is not as intuitive as in the unit ball with three dimensions, the clustering technique is fundamentally the same.

As previously noted, it has been observed that stable combustion produces random fluctuations. As such, the mapping associated with the instability during stable combustion, and therefore the point associated with the dominant eigenvector during stable combustion, will be random. However, if at least one of the burners is unstable, the resulting points will still vary, but will generally group around the point related to the mapping between the unstable burner(s) and the plurality of detectors, because all other fluctuations will be random. Thus, the points plotted on a unit ball will tend to cluster in the presence of an instability.

With further reference to FIG. 6, the subset of burners associated with the instability are identified based on the clustering 603. Additional information can be used to interpret the results of the clustering. For example, the locations of the burners and the pressure sensors can be used to constrain the Greens function. The signal frequency can likewise be used to constrain the signal function. Trial and error can also be used to assist in the interpretation of the clustering.

For example, each instance of clustering can be interpreted to produce a resulting vector. For example, the first instance of clustering can result in a first vector, while the second instance of clustering can result in a second vector. Based on experimental data and the locations of the burners and sensors, the vectors can be known to correspond to one or more unstable burners. Alternatively, such methods can be used to provide a spatial representation of an instability so that the operator of the furnace can quickly located one or more unstable burners.

The identification of one or more unstable burners allows the operator more flexibility when an instability is detected. For example, the operator can choose to deactivate the unstable burner(s) rather than shutting down the furnace as a whole. This process can also be automated such that the unstable burner is automatically deactivated when the system identifies the source of the instability. This identification also allows repairs to be made to the furnace in a timely manner by ascertaining the specific burner(s) requiring maintenance to minimize the inactivity period of the furnace.

While the systems and methods of the presently disclosed subject matter are largely directed to a furnace having multiple burners, those skilled in the art will recognize that similar techniques can be used for single burner furnaces.

The systems and methods disclosed herein can provide for continuous profile monitoring in real time of burner flame conditions within a furnace. Burner flame conditions can be measured and visualized simultaneously. For example, the conditions can be depicted on a display as a plot of stability over time. Additionally, given a furnace with multiple burners, burner flame conditions can be depicted as a spatial plot of stability.

The systems and methods disclosed herein can alert the operator of the furnace, and can be integrated with software to provide mitigation recommendations to the operator. Additionally, the systems and methods disclosed herein can provide instantaneous feedback to automatically manipulate process controls. For example, if an instability is detected, the furnace can be shut down or an operating condition of the furnace can be adjusted, such as steam and/or fuel injection.

The systems and methods disclosed herein can also provide instantaneous feedback on operating conditions to detect operating inefficiencies, e.g., uneven heating within a furnace. Based on detected conditions, the methods and systems can further provide instantaneous feedback to manually or automatically manipulate process controls to optimize furnace performance, e.g., by adjusting the amount of fuel and/or air provided to one or more burners or providing damper control.

Moreover, the system disclosed herein can operate at temperatures ranging from cryogenic temperatures up to over 1000° C. The size of the sensing cable can be relatively small (e.g., compared to conventional thermocouples) and can be cost effective for large area coverage, while providing a large amount of sensors. Utilizing cost-effective optical fiber acoustic sensors, the system disclosed herein can incorporate a large number of sensors, and can offer a high spatial resolution, e.g., less than 1 mm, over a long measurement range, e.g., several meters to kilometers. The diameter of the compact sensing cable can be small, e.g., less than 2 mm. The small diameter of the sensing cable can allow for measurement in a tight space with reduced intrusiveness.

### Additional Embodiments

Additionally or alternatively, the invention can include one or more of the following embodiments.

Embodiment 1: a method for detecting an instability in a furnace, comprising: obtaining from at least one sensor a plurality of first measurements related to the plurality of burners when the furnace is operating in a stable condition; determining, based at least in part on the plurality of first measurements from the at least one sensor, a stable signal component representation for the furnace; obtaining from the at least one sensor a plurality of second measurements related to the plurality of burners when the furnace is operating in an unknown state; determining, based at least in part on the plurality of second measurements and the stable signal component representation, an unstable signal component representation for the furnace; and detecting, using at least one processor, an instability in the furnace based at least in part on the unstable signal component representation and an instability threshold.

Embodiment 2: the method of embodiment 1, wherein the sensor is an optical fiber acoustic sensor.

Embodiment 3: the method of embodiment 1, wherein the plurality of first measurements correspond to a stable combustion frequency.

Embodiment 4: the method of embodiment 3, wherein obtaining from at least one sensor a plurality of first measurements is at a constant sampling rate that is at least twice the stable combustion frequency.

Embodiment 5: the method of embodiment 1, wherein the stable signal component comprises a sound waveform.

Embodiment 6: the method of embodiment 1, wherein the stable signal component comprises a frequency spectrum.

Embodiment 7: the method of embodiment 1, wherein the stable signal component comprises a stable covariance matrix.

Embodiment 8: the method of embodiment 1, wherein the unstable signal component comprises a sound waveform.

Embodiment 9: the method of embodiment 1, wherein the unstable signal component comprises a frequency spectrum.

Embodiment 10: the method of embodiment 1, wherein the unstable signal component comprises an instability component covariance.

Embodiment 11: the method of embodiment 10, wherein the instability component covariance is calculated based on a stable covariance matrix and a current covariance matrix.

Embodiment 12: the method of embodiment 1, wherein the instability threshold corresponds to a deviation from a stable combustion frequency.

Embodiment 13: a method for identifying, in a furnace having a plurality of burners, an unstable subset of burners from among the plurality of burners, comprising: obtaining a plurality of measurements from at least one acoustic sensor; detecting an instability associated with the furnace; computing, using at least one processor, an unstable signal matrix associated with the instability based on the at plurality of measurements; and identifying the unstable subset of burners based at least in part on the unstable signal matrix.

Embodiment 14: the method of embodiment 13, wherein the method of detecting an instability associated with the furnace comprises any of embodiments 1 through 12.

Embodiment 15: the method of embodiment 13, wherein the acoustic sensor is an optical fiber acoustic sensor.

Embodiment 16: the method of embodiment 13, further comprising using eigenvalue decomposition of the unstable signal component representation to obtain at least one dominant eigenvector.

Embodiment 17: the method of embodiment 16, wherein the at least one dominant eigenvector includes three components defining a point on a unit ball.

Embodiment 18: the method of embodiment 13, further comprising clustering a point with a plurality of other points obtained from a plurality of previous dominant eigenvectors.

Embodiment 19: the method of embodiment 18, further comprising identifying the unstable subset of burners based on the clustering.

Embodiment 20: the method of any of embodiments 1 through 19, further comprising transmitting a signal to one or more of an electronic display or an alarm.

Embodiment 21: the method of any of embodiments 13 through 20, wherein the unstable subset of burners comprises a single burner.

Embodiment 22: the method of any of embodiments 13 through 20, wherein the unstable subset of burners comprises a plurality of burners.

Embodiment 23: the method of any of embodiments 13 through 20, wherein the unstable subset of burners comprises a plurality of burners and at least one of the plurality of burners is unstable.

Embodiment 24: the method of any of embodiments 1 through 23, wherein historical data is used to detect an instability.

Embodiment 25: the method of any of embodiments 1 through 23 , wherein a data-learning algorithm is used to detect an instability.

Embodiment 26: the method of any of embodiments 1 through 23, wherein pattern recognition techniques are used to detect an instability.

Embodiment 27: a system for monitoring a condition in a furnace comprising: at least one acoustic sensor; and at least one processor coupled to the at least one acoustic sensor and configured to: receive at least one measurement from the at least one acoustic sensor; convert the at least one measurement into a digital format; and determine a condition associated with at least one burner based at least in part on the digital format.

Embodiment 28: The system of embodiment 27, wherein the acoustic sensor is configured to obtain the at least one measurement when the furnace is operating in a stable condition.

Embodiment 29: The system of embodiment 27, wherein the processor is configured to receive multiple measurements from the acoustic sensor at a constant sampling rate.

Embodiment 30: The system of embodiment 29, wherein the measurements correspond to a sound waveform having a frequency.

Embodiment 31: The system of embodiment 30, wherein the constant sampling rate is at least twice the frequency of the sound waveform.

Embodiment 32: The system of embodiment 27, wherein the digital format comprises a sound waveform.

Embodiment 33: The system of embodiment 27, wherein the digital format comprises a frequency spectrum.

Embodiment 34: the system of embodiment 27, wherein the at least one processor is configured to convert the at least one measurement into the digital format by determining, based at least in part on the at least one measurement, a stable signal component representation for the furnace.

Embodiment 35: the system of embodiment 34, wherein the at least one processor is further configured to: receive from the at least one acoustic sensor at least one second measurement when the furnace is operating in an unknown state; and determine, based at least in part on the at least one second measurement, an unstable signal component representation for the furnace.

Embodiment 36: the system of embodiment 35, wherein the at least one processor is configured to determine the condition associated with the at least one burner by detecting an instability in the furnace based at least in part on the unstable signal component representation and an instability threshold.

Embodiment 37: the system of embodiment 27, wherein the at least one processor is configured to convert the at least one measurement by computing an unstable signal matrix associated with an instability based on the at least one measurement.

Embodiment 38: the system of embodiment 37, wherein the at least one processor is configured to determine the condition associated with the at least one burner by identifying an unstable subset of burners based at least in part on the unstable signal matrix.

Embodiment 39: the system of embodiment 27, wherein the at least one acoustic sensor comprises an optical fiber.

Embodiment 40: the system of embodiment 39, wherein the optical fiber comprises fiber grating.

Embodiment 41: the system of embodiment 27, wherein the condition comprises an instability.

Embodiment 42: the system of embodiment 27, wherein the condition comprises a flameout.

Embodiment 43: the system of embodiment 27, wherein the condition comprises an irregular flame.

Embodiment 44: the system of embodiment 27, wherein determining the condition comprises analyzing the digital format against historical data.

Embodiment 45: the system of embodiment 27, wherein the one of more processors is further configured to provide one or more mitigation recommendations to an operator based on the condition.

Embodiment 46: the system of embodiment 27, wherein the digital format comprises a sound waveform.

Embodiment 47: the system of embodiment 27, wherein the digital format comprises a frequency spectrum.

1. A method for detecting an instability in a furnace having one or more burners, the method comprising:
obtaining from at least one sensor a plurality of first measurements related to the one or more burners when the furnace is operating in a stable condition;
determining, based at least in part on the plurality of first measurements from the at least one sensor, a stable signal component representation for the furnace;
obtaining from the at least one sensor a plurality of second measurements related to the one or more burners when the furnace is operating in an unknown state;
determining, based at least in part on the plurality of second measurements and the stable signal component representation, an unstable signal component representation for the furnace; and
detecting, using at least one processor, an instability in the furnace based at least in part on the unstable signal component representation and an instability threshold.

2. The method of claim 1, wherein the sensor is an optical fiber acoustic sensor.

3. The method of claim 1, wherein the plurality of first measurements correspond to a stable combustion frequency.

4. The method of claim 3, wherein the obtaining from at least one sensor a plurality of first measurements is at a constant sampling rate that is at least twice the stable combustion frequency.

5. The method of claim 1, wherein the stable signal component comprises a sound waveform.

6. The method of claim 1, wherein the stable signal component comprises a frequency spectrum.

7. The method of claim 1, wherein the stable signal component comprises a stable covariance matrix.

8. The method of claim 1, wherein the unstable signal component comprises a sound waveform.

9. The method of claim 1, wherein the unstable signal component comprises a frequency spectrum.

10. The method of claim 1, wherein the unstable signal component comprises an instability component covariance.

11. The method of claim 10, wherein the instability component covariance is calculated based on a stable covariance matrix and a current covariance matrix.

12. The method of claim 1, wherein the instability threshold corresponds to a deviation from a stable combustion frequency.

13. A method for identifying, in a furnace having a plurality of burners, an unstable subset of burners from among the plurality of burners, the method comprising:
obtaining a plurality of measurements from at least one acoustic sensor;
detecting an instability associated with the furnace;
computing, using at least one processor, an unstable signal matrix associated with the instability based on the at plurality of measurements; and
identifying the unstable subset of burners based at least in part on the unstable signal matrix.

14. The method of claim 13, wherein obtaining a plurality of measurements and detecting an instability are performed using the method of claim 1.

15. The method of claim 13, wherein the acoustic sensor is an optical fiber acoustic sensor.

16. The method of claim 13, further comprising using eigenvalue decomposition of the unstable signal component representation to obtain at least one dominant eigenvector.

17. The method of claim 16, wherein the at least one dominant eigenvector includes three components defining a point on a unit ball.

18. The method of claim 13, further comprising clustering a point with a plurality of other points obtained from a plurality of previous dominant eigenvectors.

19. The method of claim 18, further comprising identifying the unstable subset of burners based on the clustering.

20. A system for monitoring a condition in a furnace having one or more burners, comprising:
at least one acoustic sensor; and
at least one processor coupled to the at least one acoustic sensor and configured to:
receive at least one measurement from the at least one acoustic sensor;
convert the at least one measurement into a digital format; and
determine a condition associated with at least one burner based at least in part on the digital format.

21. The system of claim 20, wherein the acoustic sensor is configured to obtain the at least one measurement when the furnace is operating in a stable condition.

22. The system of claim 20, wherein the processor is configured to receive multiple measurements from the acoustic sensor at a constant sampling rate.

23. The system of claim 22, wherein the measurements correspond to a sound waveform having a frequency.

24. The system of claim 23, wherein the constant sampling rate is at least twice the frequency of the sound waveform.

25. The system of claim 20, wherein the digital format comprises a sound waveform.

26. The system of claim 20, wherein the digital format comprises a frequency spectrum.

27. The system of claim 21, wherein the at least one processor is configured to convert the at least one measurement into the digital format by determining, based at least in part on the at least one measurement, a stable signal component representation for the furnace.

28. The system of claim 27, wherein the at least one processor is further configured to:
receive from the at least one acoustic sensor at least one second measurement when the furnace is operating in an unknown state; and
determine, based at least in part on the at least one second measurement, an unstable signal component representation for the furnace.

29. The system of claim 28, wherein the at least one processor is configured to determine the condition associated with the at least one burner by detecting an instability in the furnace based at least in part on the unstable signal component representation and an instability threshold.

30. The system of claim 20, wherein the at least one processor is configured to convert the at least one measurement by computing an unstable signal matrix associated with an instability based on the at least one measurement.

31. The system of claim 30, wherein the at least one processor is configured to determine the condition associated with the at least one burner by identifying an unstable subset of burners based at least in part on the unstable signal matrix.

32. The system of claim 20, wherein the at least one acoustic sensor comprises an optical fiber.

33. The system of claim 32, wherein the optical fiber comprises fiber grating.

34. The system of claim 20, wherein the condition comprises an instability.

35. The system of claim 20, wherein the condition comprises a flameout.

36. The system of claim 20, wherein the condition comprises an irregular flame.

37. The system of claim 20, wherein determining the condition comprises analyzing the digital format against historical data.

38. The system of claim 20, wherein the one of more processors is further configured to provide one or more mitigation recommendations to an operator based on the condition.
